(19) United States
(12) Patent Application Publication
(10) Pub. No.: US 2012/0275300 A1
(43) Pub. Date: Nov. 1, 2012

(54) SERVICE EVENT TRIGGER

(75) Inventor: Miguel Angel Muñoz de la Torre Alonso, Madrid (ES)

(73) Assignee: TELEFONAKTIEBOLAGET L M ERICSSON (PUBL), Stockholm (SE)

(21) Appl. No.: 13/509,156

(22) PCT Filed: Nov. 13, 2009
(86) PCT No.: PCT/EP2009/065161

§ 371 Date: Jun. 4, 2012

(51) Int. Cl. H04W 28/02

(52) U.S. Cl. 370/229

(57) ABSTRACT

A Policy and Charging Enforcement Function (PCEF) node for a telecommunications network has a service traffic detector, for performing service traffic detection during a session. A processor detects a predetermined service condition from said service traffic detection. The PCEF notifies a Policy and Charging Rule Function (PCRF) of the detected service condition by means of a service event defined in an Event Trigger AVP over a Gx reference point. The PCRF receives the notification of the detected service condition, and controls the service provision in response to the detected service condition, for example by controlling the Quality of Service applied to the service.

### TECHNICAL FIELD

This invention relates to a service event trigger, and more particularly to a service event trigger for allowing modification of the Quality of Service parameters for a user session based on changes in the session.

### BACKGROUND

In the core network of a mobile communications network, resources must be provided for transmitting data between two users, and the resources that are provided determine the Quality of Service experienced by the users. In a network as defined by the ETSI 3rd Generation Partnership Project (3GPP), there are defined a Policy and Charging Rule Function (PCRF), a Policy and Charging Enforcement Function (PCEF), and a Gx reference point lying between the PCRF and the PCEF. As defined in 3GPP TS 29.212, the Gx reference point is used for provisioning and removal of Policy and Charging Control (PCC) rules from the PCRF to the PCEF and the transmission of traffic plane events from the PCEF to the PCRF. Thus, the Gx reference point can be used for charging control, policy control or both.

In the case of a network as defined in the 3GPP, the PCEF can be implemented in a Gateway GPRS Support Node (GGSN), and it is known for a GGSN to be able to support Deep Packet Inspection (DPI) technology, which allows the node to perform packet inspection and service classification on the data passing therethrough. More specifically, IP packets are classified according to a configured tree of rules so that they are assigned to a particular service session.

However, the known use of DPI technology in the GGSN does not allow any differentiation of the service based on the service classification.

### SUMMARY

According to a first aspect of the present invention, there is provided a Policy and Charging Enforcement Function node for a telecommunications network, comprising: a service traffic detector, for performing service traffic detection during a session; a processor, for detecting a predetermined service condition from said service traffic detection; and an interface, for notifying a Policy and Charging Rule Function of the detected service condition by means of a service event defined in an Event Trigger AVP over a Gx reference point.

This has the advantage that the Policy and Charging Rule Function is able to install suitable Policy and Charging Control rules, for example to allow a desired Quality of Service to be achieved for the detected service condition.

In one embodiment, the interface is further adapted to notify the Policy and Charging Rule Function whether the detected service condition is a service start or a service stop by means of a service start-stop AVP over the Gx reference point. This allows the Policy and Charging Rule Function to install suitable Policy and Charging Control rules when a service is started, and then to reinstate the original Policy and Charging Control rules when a service is stopped.

In one embodiment, the interface is further adapted to notify the Policy and Charging Rule Function of an associated IP address by means of an IP address AVP over the Gx reference point and to notify the Policy and Charging Rule Function of flow information for the session by means of another AVP, such as a Media-Content-description AVP.

In one embodiment, the interface is further adapted to notify the Policy and Charging Rule Function of a service to which the detected service condition applies by means of an application identifier AVP over the Gx reference point.

According to other aspects of the invention, there are provided a Policy and Charging Rule Function configured to receive notification from the Policy and Charging Enforcement Function node, and methods of operation, corresponding to the Policy and Charging Enforcement Function of the first aspect.

### BRIEF DESCRIPTION OF THE DRAWINGS

FIG. 1 is a block schematic diagram, showing a part of a telecommunications network in accordance with an aspect of the invention.

FIG. 2 is a flow chart, illustrating a method in accordance with an aspect of the invention.

FIG. 3 shows the message flow during a first part of the method of FIG. 2.

FIG. 4 shows the message flow during a second part of the method of FIG. 2.

### DETAILED DESCRIPTION

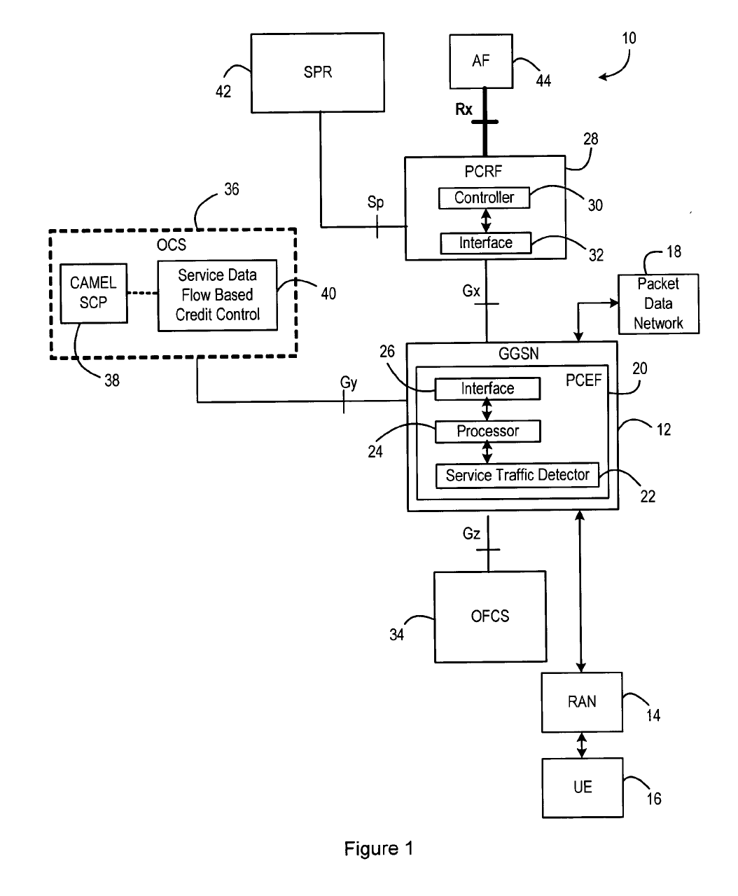

FIG. 1 shows a part of a telecommunications network, in particular a part of a Core Network 10 of a mobile communications network as defined in the 3GPP specifications.

One element of the Core Network 10 is the Gateway GPRS Support Node (GGSN) 12. As is conventional, the Radio Access Network (RAN) 14 of the mobile communications network is connected to the GGSN 12, allowing a User Equipment (UE) 16 to establish a call over a suitable wireless interface. The call can be routed back through the RAN 14 to another UE in the network, or it can be connected over a Packet Data Network 18, such as the internet, to a fixed line or mobile communications device or, in the case of a data session, to a remote server. This aspect of the network is conventional, and will not be described further herein.

As is also conventional, the GGSN 12 includes the Policy and Charging Enforcement Function (PCEF). In this case, the PCEF is included in a GGSN that has a service traffic detection block 22, enabling it to perform Deep Packet Inspection (DPI). This allows packet inspection and service classification, which consists of classifying IP packets according to a configured tree of rules so that they are assigned to a particular service session. The node with DPI capabilities captures the user and signaling traffic, and is able to assign IP packets to a particular service session and also to detect service start and service stop conditions.

The PCEF also includes a processor 24, which performs a part of the process described in more detail below, and an interface block 26, for connection to other blocks in the Core Network 10.

Although FIG. 1 shows the service traffic detection block 22, processor 24, and interface block 26 as separate blocks for ease of understanding, it will be appreciated that the relevant functions can be performed by any convenient means, and that these blocks need not be recognizable as distinct in practice.

In other embodiments of the invention, the PCEF can be implemented in the Packet Data Network (PDN) Gateway.

As is conventional, the Core Network 10 also includes a Policy and Charging Rule Function (PCRF) 28, the structure of which is again generally conventional, including a processor 30, which performs a part of the process described in more detail below, and an interface block 32, for connection to other blocks in the Core Network 10. For example, the PCRF 28 can be implemented in an Ericsson Service-Aware Policy Controller (SAPC).

Although FIG. 1 shows the processor 30 and the interface block 32 as separate blocks for ease of understanding, it will be appreciated that the relevant functions can be performed by any convenient means, and that these blocks need not be recognizable as distinct in practice.

The PCEF 20 is also connected to an Offline Charging System (OFCS) 34 and an Online Charging System 36, which includes a Customised Applications for Mobile network Enhanced Logic (CAMEL) Service Control Point 38 and a Service Data Flow Based Credit Control block 40.

The PCRF 28 is connected to a Subscription Profile Repository (SPR) 42, and to an Application Function (AF) 44. For example, the AF 44 may be the IP Multimedia Subsystem (IMS) Proxy Call Session Control Function (P-CSCF).

The PCEF 20 and the PCRF 28 communicate over the Gx reference point, as defined in 3GPP TS 29.212. The Gx reference point is used for provisioning and removal of PCC rules from the PCRF to the PCEF and the transmission of traffic plane events from the PCEF to the PCRF. The Gx reference point can be used for charging control, policy control or both.

The PCRF 28 and the AF 44 communicate over the Rx reference point, as defined in 3GPP TS 29.214, which is used to exchange application level session information between the PCRF and the AF.

The PCEF 20 and the OFCS 34 communicate over the Gz reference point, while the PCEF 20 and the OCS 36 communicate over the Gy reference point, and the PCRF 28 and the SPR 42 communicate over the Sp reference point.

The general structure described above is shown in 3GPP TS 29.212, and so will not be described further herein.

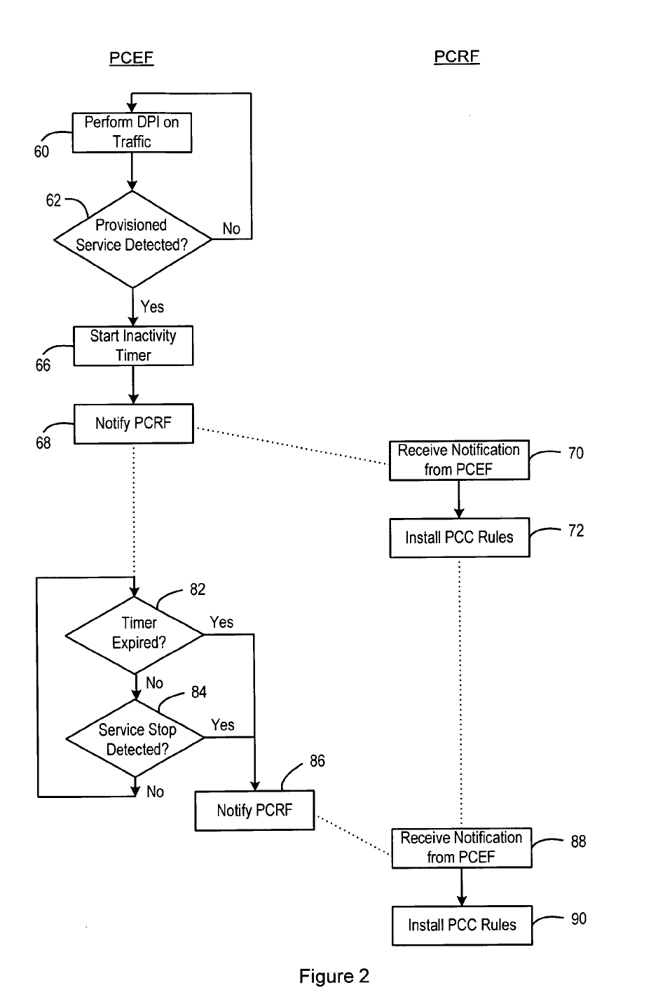

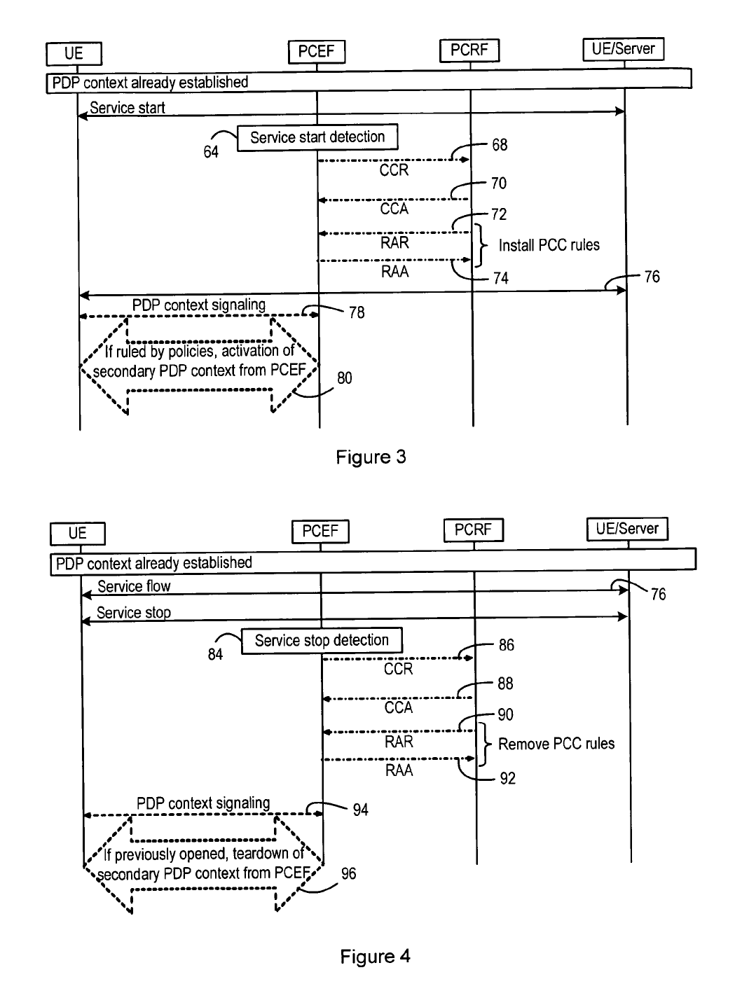

A method in accordance with the present invention will now be described in more detail with reference to FIG. 2, in the form of a flow chart, and FIGS. 3 and 4, showing the message flow between the various nodes. Specifically, FIG. 2 shows steps performed in the PCEF 20 and the PCRF 28, while FIGS. 3 and 4 show messages transmitted between the UE 16, the PCEF 20, the PCRF 28, and the other UE or server to which the UE 16 is connected.

The process starts at a time when the UE 16 already has a general purpose Packet Data Protocol (PDP) context established with the remote UE/server. In step 60, the PCEF performs Deep Packet Inspection (DPI), or another form of service traffic detection, on the data traffic.

Before beginning the process, the PCEF is provisioned with a set of services, for which events should be notified to the PCRF. For example, the system may be configured in such a way that certain services are identified as premium content, while other services are identified as non-premium content. As more specific examples, time-critical music or video clips, or an operator's own portal may be specifically identified as premium content, while services such as peer-to-peer file exchanges might be regarded as non-premium content. The PCEF might be configured to recognize any of these services. The PCRF should be provisioned with the same set of services, and with a policy that will apply for each of those services.

Thus, in step 62, the PCEF monitors the traffic, until it detects the start of one of the provisioned services, also indicated at point 64 in FIG. 3. The PCEF can detect the start of the service by any suitable technique, for example using heuristic methods, enabled by the use of DPI.

When the PCEF detects the service start condition, in step 66 it starts an inactivity timer. Then, in step 68, the PCEF 20 notifies the PCRF 28 of the service start condition by means of a credit control request (CCR) command over the Gx interface by using the Event-Trigger AVP set to a value indicating a newly-defined SERVICE event.

In this illustrated embodiment of the invention, a newly-defined Service_Information AVP is used to convey additional information to allow the PCRF to handle this notification.

A Service-Start-Stop AVP indicates if the event corresponds to either a service start or a service stop (thus, in this case, it is set to indicate a service start event).

A Framed-IP-Address AVP contains the IP-CAN session associated IP address, encoded as specified in RFC 4005. Another AVP, such as the Media-Component-Description AVP, contains relevant flow information. For example, RTSP signalling conveys information about the IP addresses and ports corresponding to the Real-time Transport Protocol (RTP) audio or video data flows negotiated during signalling, so that the PCRF may create secondary PDP contexts under those negotiated IP addresses and ports.

An Application-Identifier AVP contains information that identifies the particular service detected (for example Real-Time Streaming Protocol (RTSP)). This information may be used by the PCRF to provided differentiated QoS for different application services.

At step 70, the PCRF receives the notification from the PCEF, and signals this by sending a credit control answer (CCA) message with a result code indicating that the notification was a success.

At step 72, the PCRF installs the corresponding PCC rules by transmitting to the PCEF the Gx reauthorization request (RAR) message. This allows the modification of the existing bearer (or the creation of a dedicated bearer) with either higher or lower QoS settings, depending on the service which is being started. At step 74, the PCEF acknowledges this command, by sending to the PCRF a reauthorization answer with a result code indicating that the notification was a success.

In response to the notification, the PCRF may take any suitable steps for controlling the service provision in response to the detected service condition. This may involve modification of the QoS settings for the service session, and this in turn may consist of any of the following actions from a non-exhaustive list containing: Gx initiated PDP context modification (i.e. when a GGSN acts as the PCEF); change of traffic handling priority (THP) for the existing bearer; change of maximum bit rate (MBR) for the existing bearer; IP Flow Bandwidth Management; or network initiation of a dedicated IP-CAN bearer with dynamic PCC rules (i.e. when a GGSN acts as the PCEF).

For example, a better QoS can be provided for certain premium services, such as a network operator's portal page, ring tones, music or video clips or 3rd party peered content, in order to guarantee the bandwidth required by that particular service, while a worse QoS can be provided for certain low value services, such as peer-to-peer file exchanges, non-sponsored downloads and the like, such that these services receive their full bandwidth requirement only when available.

It should be noted that it would also be possible to trigger any other action when the PCRF is notified of the service start condition.

Thereafter, the service flow can take place, as shown at 76 in FIG. 3, with the appropriate service policies applied. As indicated by way of example at 78 in FIG. 3, and as mentioned above, this may require appropriate PDP context signalling, to establish a secondary PDP context 80 between the UE 16 and the PCEF 20. In other cases, the service may be carried over the existing PDP context, and it is not necessary to create a secondary PDP context.

While the detected service in is progress, the PCEF performs step 82 of the process shown in FIG. 2, in order to determine whether the inactivity timer has expired (i.e. whether the service has been inactive for a predetermined period of time set by the timer). If not, the process passes to step 84, in which it is determined whether a service stop condition is detected. If not, the process returns to step 82. The PCEF can detect the stopping of the service by any suitable technique, for example using heuristic methods, enabled by the use of DPI.

If it is determined in step 82 that the inactivity timer has expired, or it is determined in step 84 that the service stop condition is detected, the process passes to step 86, in which the PCEF 20 notifies the PCRF 28 by means of a credit control request (CCR) command over the Gx interface by using the Event-Trigger AVP set to the value indicating the newly-defined SERVICE event.

In this illustrated embodiment of the invention, the newly-defined Service_Information AVP is used to convey additional information to allow the PCRF to handle this notification.

The Service-Start-Stop AVP in this case is set to indicate a service stop event. The Framed-IP-Address AVP contains the IP-CAN session associated IP address, encoded as specified in RFC 4005. Another AVP, such as the Application-Identifier AVP contains information that identifies the particular service detected (for example Real-Time Streaming Protocol (RTSP)).

At step 88, the PCRF receives the notification from the PCEF, and signals this by sending a credit control answer (CCA) message with a result code indicating that the notification was a success.

At step 90, the PCRF removes the previously installed PCC rules by transmitting to the PCEF the Gx reauthorization request (RAR) message. This allows the restoration of the original QoS settings, by the modification of the existing bearer (or the deletion of the dedicated bearer created for that service). At step 92, the PCEF acknowledges this command, by sending to the PCRF a reauthorization answer with a result code indicating that the notification was a success.

As shown in FIG. 4, where a secondary PDP context was established between the UE 16 and the PCEF 20, appropriate PDP context signalling 94 can be used to tear down the secondary PDP context at step 96.

The invention has been described above with reference to the situation where the PCEF reacts to a predetermined service condition in the form of a service start or a service stop of a specified service. A similar procedure can be followed in the event of a service update.

For example, when a user pauses a running streaming service or when a new flow is added to an existing service, such as adding a video component to an existing IMS voice call, this can be detected by the PCEF by any suitable technique, for example using heuristic methods, enabled by the use of DPI.

The Service-Start-Stop AVP in this case is set to indicate a service update event, and the notification to the PCRF might trigger modification of QoS parameters for the service session.

As described so far, the method involves transmission over the Gx interface. However, a local solution, with no Gx involvement, is also possible. In that case, the PCEF should be provisioned with a set of services (for example such as RTSP, as described previously), for which this functionality should be triggered and should also be provisioned with the local policy that will apply for each of those services. The PCEF can be configured to detect the service start condition, as described above, and on such detection, the PCEF starts an inactivity timer. Based on the local policies provisioned for that service, the PCEF may then trigger the modification of the existing bearer, or the creation of a dedicated bearer, with either higher or lower QoS settings, depending on the service which is being started. When the PCEF detects the service stop condition, or the inactivity timer expires, the PCEF (based on the local policies provisioned for that service) should restore the previous QoS settings, by modifying the existing bearer or by deleting the dedicated bearer previously created for the service.

There is thus provided an enhancement to the Gx interface allowing a PCEF that is able to perform service traffic detection to notify a PCRF of a service condition, by means of a specific event in the Event-Trigger AVP. This allows the PCRF to install the corresponding PCC rules in order to modify the QoS parameters for that particular user session.

1.-20. (canceled)

21. A Policy and Charging Enforcement Function node for a telecommunications network, comprising:
a service traffic detector configured to perform service traffic detection during a session;
a processor configured to detect a predetermined service condition from the service traffic detection;
an interface configured to notify a Policy and Charging Rule Function (PCRF) of the detected service condition by means of a service event defined in an Event Trigger Attribute-Value Pair (AVP) over a Gx reference point,
wherein the processor is configured to determine whether a service stop condition is detected;
wherein the interface is configured to notify the PCRF by means of a service stop event in response to the processor determining that a service stop condition is detected.

22. The node of claim 21:
further comprising a timer;
wherein the processor is further configured to determine whether the timer has expired;
wherein the interface is further configured to notify the PCRF by means of a service stop event in response to the processor determining that the timer has expired.

23. The node of claim 21 wherein the interface is further configured to notify the PCRF whether the detected service condition is a service start or a service stop by means of a service start-stop AVP over the Gx reference point.

24. The node of claim 21 wherein the interface is:
further configured to notify the PCRF of an associated IP address for the session by means of an IP address AVP over the Gx reference point;
further configured to notify the PCRF of flow information by means of a Media-Component-Description AVP over the Gx reference point.

25. The node of claim 21 wherein the interface is further configured to notify the PCRF of a service to which the detected service condition applies by means of an application identifier AVP over the Gx reference point.

26. A method for controlling service provision in a Policy and Charging Enforcement Function node of a telecommunications network, the method comprising:
performing service traffic detection during a session;
detecting a predetermined service condition from the service traffic detection;
notifying a Policy and Charging Rule Function (PCRF) of the detected service condition by means of a service event defined in an Event Trigger Attribute-Value Pair (AVP) over a Gx reference point;
determining whether a service stop condition is detected;
wherein the notifying the PCRF of the detected service condition comprises notifying the PCRF by means of a service stop event in response to a service stop condition being determined to be detected.

27. The method of claim 26:
further comprising determining whether a timer has expired;
wherein the notifying the PCRF of the detected service condition comprises notifying the PCRF by means of a service stop event in response to the timer being determined to have expired.

28. The method of claim 26 further comprising notifying the PCRF whether the detected service condition is a service start or a service stop by means of a service start-stop AVP over the Gx reference point.

29. The method of claim 26 further comprising:
notifying the PCRF of an associated IP address for the session by means of an IP address AVP over the Gx reference point;
notifying the PCRF of flow information by means of a Media-Component-Description AVP over the Gx reference point.

30. The method of claim 26 further comprising notifying the PCRF of a service to which the detected service condition applies by means of an application identifier AVP over the Gx reference point.

31. A Policy and Charging Rule Function node for a telecommunications network, comprising:
an interface configured to receive notification from a Policy and Charging Enforcement Function (PCEF) of a detected predetermined service condition by means of a service event defined in an Event Trigger Attribute-Value Pair (AVP) over a Gx reference point;
a controller configured to control a service provision in response to the detected service condition;
wherein the interface is further configured to receive notification from the PCRF of a determination that a service stop condition is detected by means of a service stop event.

32. The node of claim 31 wherein the interface is further configured to receive notification from the PCRF of a determination that a timer has expired by means of a service stop event.

33. The node of claim 31 wherein the interface is further configured to receive notification whether the detected service condition is a service start or a service stop by means of a service start-stop AVP over the Gx reference point.

34. The node of claim 31 wherein the interface is further configured to:
receive notification of an associated IP address for the session by means of an IP address AVP;
receive flow information by means of a Media-Component-Description AVP over the Gx reference point.

35. The node of claim 31 wherein the interface is further configured to receive notification of a service to which the detected service condition applies by means of an application identifier AVP over the Gx reference point.

36. A method for controlling service provision in a node of a telecommunications network, the method comprising:
in a Policy and Charging Enforcement Function:
performing service traffic detection during a session;
detecting a predetermined service condition from the service traffic detection;
notifying a Policy and Charging Rule Function (PCRF) of the detected service condition by means of a service event defined in an Event Trigger Attribute-Value Pair (AVP) over a Gx reference point;
determining whether a service stop condition is detected;
wherein the notifying the PCRF of the detected service condition comprises notifying the PCRF by means of a service stop event in response to a service stop condition being determined to be detected;
in the PCRF:
receiving notification of the detected service condition by means of the service stop event;
controlling the service provision in response to the detected service condition.

37. The method of claim 36:
further comprising the Policy and Charging Enforcement Function determining whether a timer has expired;
wherein the notifying the PCRF of the detected service condition further comprises notifying the PCRF by means of a service stop event in response to the timer being determined to have expired.

38. The method of claim 36 further comprising the Policy and Charging Enforcement Function notifying the PCRF whether the detected service condition is a service start or a service stop by means of a service start-stop AVP over the Gx reference point.

39. The method of claim 36 further comprising the Policy and Charging Enforcement Function:
notifying the PCRF of an associated IP address for the session by means of an IP address AVP over the Gx reference point;
notifying the PCRF of flow information by means of a Media-Component-Description AVP over the Gx reference point.

40. The method of claim 36 further comprising the Policy and Charging Enforcement Function notifying the PCRF of a service to which the detected service condition applies by means of an application identifier AVP over the Gx reference point.
